(19) United States
(12) Patent Application Publication
(10) Pub. No.: US 2024/0247083 A1
(43) Pub. Date: Jul. 25, 2024

(54) HYDROGENATED POLYETHER-MODIFIED POLYBUTADIENES AND PROCESSES FOR PREPARATION THEREOF

(71) Applicant: Evonik Operations GmbH, Essen (DE)

(72) Inventors: Matthias Lobert, Essen (DE); Sarah Otto, Essen (DE); Michael Urban, Essen (DE); Frank Schubert, Neukirchen-Vluyn (DE); Frauke Henning, Essen (DE)

(73) Assignee: Evonik Operations GmbH, Essen (DE)

(21) Appl. No.: 18/563,143

(22) PCT Filed: May 16, 2022
(86) PCT No.: PCT/EP2022/063153

§ 371 Date: Nov. 21, 2023

(30) Foreign Application Priority Data
May 27, 2021 (EP) 21176122.6

(51) Int. Cl. C08C 19/40; C08C 19/06; C08G 59/02; C08G 59/34; C08G 65/26

(52) U.S. Cl. CPC C08C 19/40; C08C 19/06; C08G 59/027; C08G 59/34; C08G 65/2609

(57) ABSTRACT

A process for preparing hydrogenated polyether-modified polybutadienes includes: reacting at least one polybutadiene with at least one epoxidizing reagent to give at least one epoxy-functional polybutadiene; reacting the at least one epoxy-functional polybutadiene with at least one hydroxy-functional compound to give at least one hydroxy-functional polybutadiene; reacting the at least one hydroxy-functional polybutadiene with at least one epoxy-functional compound to give at least one polyether-modified polybutadiene; and hydrogenating the at least one polyether-modified polybutadiene to give at least one hydrogenated polyether-modified polybutadiene.

The invention relates to a process for preparing hydrogenated polyether-modified polybutadienes and to hydrogenated polyether-modified polybutadienes preparable by this process.

Polybutadienes having pendant polyether radicals are known and are prepared according to the prior art, for example, by a reaction of reactive functionalized polybutadienes with polyethers. For instance, Q. Gao et. al. in Macromolecular Chemistry and Physics (2013), 214(15), 1677-1687 describe amphiphilic polymer comb structures that are prepared by grafting polyethylene glycol onto a main polybutadiene chain. According to JP 2011038003, polybutadienes functionalized with maleic anhydride units are reacted with amino-terminated polyethers. The result is maleinized polybutadienes having polyether radicals in comb positions, attached via an amide or imide group. In a similar process, according to J. Wang, Journal of Applied Polymer Science (2013), 128(4), 2408-2413, polyethylene glycols are added onto polybutadienes having a high proportion of 1.2-butadiene monomer units to form an ester linkage. High molecular weight graft polymers having comb structure are obtained by the process disclosed in JP 2002105209 by an addition of epoxidized polybutadienes with OH-functional polyethers. H. Decher et al., according to Polymer International (1995), 38(3), 219-225, use the addition of isocyanate-terminated polyethylene glycols onto hydroxy-functional polybutadienes.

Also known are processes for preparing polyether-modified polybutadienes in which hydroxy-functional polybutadienes are reacted with epoxy compounds. For example, the prior art discloses the alkoxylation of OH-terminated polybutadienes.

U.S. Pat. No. 4,994,621 A describes, for example, the alkoxylation of hydroxy-terminated polybutadienes with ethylene oxide and propylene oxide in the presence of tetramethylammonium hydroxide. EP 2003156 A1 states that the alkali-catalysed alkoxylation of OH-terminated polybutadienes is barely possible for structural reasons and as a result of the poor solubility of alkaline catalysts, and instead prefers double metal cyanide (DMC) catalysis. The use of OH-terminated polybutadienes in alkoxylation leads exclusively to polyether-polybutadiene-polyether triblock structures. According to EP 2003156 A1, this block structure is responsible for the poor miscibility with other reaction components in the preparation of polyurethanes.

As well as the alkoxylation of OH-terminated polybutadienes, the alkoxylation of pendantly hydroxy-functional polybutadienes is also known. For instance, Q. Gao et al. in Macromolecular Chemistry and Physics (2013), 214(15), 1677-1687 describe the preparation of a pendently polyether-modified polybutadiene by alkoxylation of a pendantly hydroxy-functional polybutadiene with ethylene oxide. The pendantly hydroxy-functional polybutadiene used here is prepared first by epoxidation of a polybutadiene, followed by reaction of the epoxidized polybutadiene with a lithium-polybutadiene compound, and finally protonation of the reaction product with methanolic HCl. This process leads to a polybutadiene having both pendant polyether radicals, and also pendant polybutadiene radicals. Since there is always a polybutadiene radical for every polyether radical here, this process leads to polyether-modified polybutadienes having low HLB values (HLB˜hydrophilic lipophilic balance). Moreover, the polyether-modified polybutadienes are branched in the polybutadiene moiety. Polyether-modified polybutadienes having higher HLB values and/or an unbranched polybutadiene moiety are not preparable by this process. A further disadvantage of the process is the use of organometallic compounds (n-BuLi and lithium-polybutadiene), which places particular demands on the process regime owing to their high air and moisture sensitivity. This makes it difficult to implement this process industrially.

The chemical modification of polybutadiene with the aid of epoxidation and further reactions is known from the literature. The epoxy ring opening usually takes place by a reaction with amines. JP 53117030 and DE 2943879 describe the addition of ethanolamine or diethanolamine, EP 351135 and DE 3305964 the reaction of the epoxy groups with dimethylamine. DD 206286 discloses the addition of primary and secondary amines having 4 to 20 carbon atoms onto epoxidized polybutadienes in polar solvents. Also known is the modification of polybutadiene with fatty acids. For instance, DE 3442200 describes the addition of C₆-C₂₂-carboxylic acids onto epoxidized polybutadiene. No further alkoxylation of the reaction products is disclosed in these documents.

In the context of the present invention, amine-functional polybutadienes are not very suitable as starter compounds for the alkoxylation since they impart an often undesirable basic character to the products, cause discoloration or, for example, inhibit alkoxylation catalysts such as double metal cyanides.

According to the prior art, the addition of alcohols and water onto epoxidized polybutadiene seems to be far more difficult than the addition of amines and carboxylic acids. Qing Gao et al. in J. Macromol. Sci., Part A: Pure and Applied Chemistry (2013), 50, 297-301 describe the trifluoromethanesulfonic acid-catalysed addition of water onto epoxidized polybutadienes in THF. The aim of WO 2016/142249 A1 is the preparation of vitreous polymers by addition of water or alcohols having 1 to 4 carbon atoms onto the epoxy groups of polybutadiene and is limited to the preparation of OH-functional polybutadienes having low molar masses of 300 to 2000 g/mol and a high content of 50% to 80% of 1,2-vinylic and 1.2-cyclovinylic double bonds.

Polybutadienes and modified polybutadienes are in many cases used as reactive component or formulation constituent in order, for example, to render polymers hydrophobic or to flexibilize them and improve mechanical properties. At present, however, there are frequently limits to the possible uses of alkoxylated polyether-modified polybutadienes as a result of the restriction to a small number of available triblock structures. There has therefore been no way of varying to a large degree the chemical makeup of the polyether-modified polybutadienes. Moreover, there is no simple preparation process for such polymers.

The hydrogenation of unsaturated compounds in general and in particular unsaturated polymers such as polybutadiene polymers or polybutadiene-isoprene copolymers are known in principle and may be carried out both with heterogeneous and homogeneous catalysts.

Hydrogenation catalysts familiar to those skilled in the art are, for example, of the nickel type, such as Raney nickel, or also palladium. Whereas nickel-catalysed reactions are usually characterized by a low reaction rate, a significantly faster reaction occurs with palladium catalysis.

For instance, DE 2459115 A1 describes the hydrogenation of polybutadienes in the presence of supported ruthenium catalysts and DE 1248301 B describes the use of cobalt, nickel, manganese, molybdenum and tungsten compounds, which are applied to inert support materials by aluminium reducing agents, as efficient heterogeneous hydrogenation catalysts. DE 2457646 A1 also describes an efficient hydrogenation catalyst based on cobalt, prepared from Co(II) chloride by a reducing reaction with lithium, sodium or potassium salts of a lactam.

Furthermore, DE 2637767 A1 also describes triphenylphosphine salts of rhodium (Wilkinson's catalyst), iridium and ruthenium as selective catalysts for the hydrogenation of the 1,2-vinyl moieties of the polybutadiene polymer. In addition, Wilkinson's catalyst is also used advantageously as a polymer-bound catalyst in EP 0279766 A1.

EP 0545844 A1 describes a titanocene catalyst as homogeneous catalyst, which is converted into its active form by in situ reduction with organometallic compounds.

However, no hydrogenated polyether-modified polybutadienes and accordingly no processes for preparation thereof are known from the prior art.

The object of the present invention, therefore, was to prepare hydrogenated polyether-modified polybutadienes.

It has now been found, surprisingly, that a process for preparing hydrogenated polyether-modified polybutadienes, comprising the following steps, achieves this object:
a) reacting at least one polybutadiene (A) with at least one epoxidizing reagent (B) to give at least one epoxy-functional polybutadiene (C);
b) reacting the at least one epoxy-functional polybutadiene (C) with at least one hydroxy-functional compound (D) to give at least one hydroxy-functional polybutadiene (E);
c) reacting the at least one hydroxy-functional polybutadiene (E) with at least one epoxy-functional compound (F) to give at least one polyether-modified polybutadiene (G):
d) hydrogenating the at least one polyether-modified polybutadiene (G) to give at least one hydrogenated polyether-modified polybutadiene (H).

Further subject matters of the invention and advantageous embodiments thereof can be found in the claims, the examples and the description.

The subject matter of the invention is described by way of example below but without any intention that the invention be restricted to these illustrative embodiments. Where ranges, general formulae or classes of compounds are specified below, these are intended to encompass not only the corresponding ranges or groups of compounds that are explicitly mentioned but also all subranges and subgroups of compounds that can be obtained by removing individual values (ranges) or compounds. Where documents are cited in the context of the present description, the entire content thereof is intended to be part of the disclosure content of the present invention.

Where average values are stated hereinbelow, these values are numerical averages unless otherwise stated. Where measured values, parameters or material properties determined by measurement are stated hereinbelow, these are, unless otherwise stated, measured values, parameters or material properties measured at 25° C. and preferably at a pressure of 101 325 Pa (standard pressure).

In the context of the present invention, number-average molar mass Mn, weight-average molar mass M_{w} and polydispersity (M_{w}/Mₙ) are preferably determined by means of gel permeation chromatography (GPC) as described in the examples.

Where numerical ranges in the form “X to Y” are stated hereinbelow, where X and Y represent the limits of the numerical range, this is synonymous with the statement “from at least X up to and including Y”, unless otherwise stated. Stated ranges thus include the range limits X and Y, unless otherwise stated.

The terms “pendant”, “lateral” and “in comb positions” are used synonymously.

Wherever molecules/molecule fragments have one or more stereocentres or can be differentiated into isomers on account of symmetries or can be differentiated into isomers on account of other effects, for example restricted rotation, all possible isomers are included by the present invention.

The formulae below describe compounds or radicals that are constructed from optionally repeating units (repeat units), for example repeating fragments, blocks or monomer units, and may have a molar mass distribution. The frequency and number of the units is specified by indices unless explicitly stated otherwise. The indices used in the formulae should be regarded as statistical averages (numerical averages). The indices used and also the value ranges of the reported indices should thus be regarded as averages of the possible statistical distribution of the structures that are actually present and/or mixtures thereof, unless explicitly stated otherwise. The various fragments or units of the compounds described in the formulae below may be distributed statistically. Statistical distributions have a blockwise structure with any number of blocks and any sequence or are subject to a randomized distribution; they may also have an alternating structure or else form a gradient along the chain, where one is present; in particular they can also give rise to any mixed forms in which groups having different distributions may optionally follow one another. The formulae below include all permutations of units. Where compounds such as polybutadienes (A), epoxy-functional polybutadienes (C), hydroxy-functional polybutadienes (E), polyether-modified polybutadienes (G) or hydrogenated polyether-modified polybutadienes (H), for example, that can have multiple instances of different units are described in the context of the present invention, these may thus occur in these compounds either in an unordered manner, for example in statistical distribution, or in an ordered manner. The figures for the number or relative frequency of units in such compounds should be regarded as an average (numerical average) over all the corresponding compounds. Specific embodiments may lead to restrictions on statistical distributions as a result of the embodiment. For all regions unaffected by such restriction, the statistical distribution is unchanged.

The invention thus firstly provides a process for preparing one or more hydrogenated polyether-modified polybutadienes, comprising the steps of:
a) reacting at least one polybutadiene (A) with at least one epoxidizing reagent (B) to give at least one epoxy-functional polybutadiene (C);
b) reacting the at least one epoxy-functional polybutadiene (C) with at least one hydroxy-functional compound (D) to give at least one hydroxy-functional polybutadiene (E);
c) reacting the at least one hydroxy-functional polybutadiene (E) with at least one epoxy-functional compound (F) to give at least one polyether-modified polybutadiene (G);
d) hydrogenating the at least one polyether-modified polybutadiene (G) to give at least one hydrogenated polyether-modified polybutadiene (H).

It is preferable that the process of the invention additionally includes precisely one of the following two optional steps cc) and dd):
cc) reacting at least one polyether-modified polybutadiene (G) without end-capped polyether radicals with at least one end-capping reagent (I) to give at least one polyether-modified polybutadiene (G) comprising end-capped polyether radicals;
dd) reacting at least one hydrogenated polyether-modified polybutadiene (H) without end-capped polyether radicals with at least one end-capping reagent (1) to give at least one hydrogenated polyether-modified polybutadiene (H) comprising end-capped polyether radicals.

It is therefore preferable that the process of the invention includes either step cc) or step dd) or neither of these two steps.

The polyether-modified polybutadiene (G) without end-capped polyether radicals is also referred to below as (G1). The polyether-modified polybutadiene (G) comprising end-capped polyether radicals is also referred to below as (G2). Both (G1) and (G2) are polyether-modified polybutadienes (G).

The hydrogenated polyether-modified polybutadiene (H) without end-capped polyether radicals is also referred to below as (H1). The hydrogenated polyether-modified polybutadiene (H) comprising end-capped polyether radicals is also referred to below as (H2). Both (H1) and (H2) are hydrogenated polyether-modified polybutadienes (H).

It is preferable that the process of the invention additionally includes the following optional step e):
e) colour lightening of the at least one hydrogenated polyether-modified polybutadiene (H).

The steps a), b), c), cc) d), dd) and e) are carried out in this sequence, i.e. in the sequence a), b), c), cc) d), dd) and e), in which the steps cc), dd) and e) are optional and may be omitted, in which either the step cc) or the step dd) or neither of these two steps are included. The process steps may follow each other directly. The process may however have further upstream steps, intermediate steps or downstream steps, such as purification of the reactants, the intermediates and/or the end products.

By means of the process according to the invention, it will be possible for the first time to obtain hydrogenated polyether-modified polybutadienes, especially linear hydrogenated polybutadienes having polyether radicals in comb positions. The chain length and monomer sequence in the polyether radical may be varied within wide ranges. The average number of polyether radicals bonded to the polybutadiene is adjustable in a controlled manner via the degree of epoxidation and the hydroxy functionalization and opens up a great structural variety in the hydrogenated polyether-modified polybutadienes (H).

The grafting of polyethers onto polybutadiene known in the prior art is rarely quantitative in practice, and the reaction products typically contain free proportions of polyethers and possibly unfunctionalized polybutadienes. The above-described addition of OH-functional polyethers via their OH groups onto epoxidized polybutadienes is likewise usually incomplete, and the products contain residual unconverted epoxy groups. If the polyethers are used in excess, it is possible to reduce the residual content of epoxy groups, but the excess polyethers remain in the product since they cannot be removed by distillation.

The hydrogenated polybutadienes having polyether radicals in comb positions that are obtainable in accordance with the invention are preferably essentially free of residual epoxy groups. The process product according to the invention preferably contains essentially no free polyether components. Preferably, essentially all polyethers are chemically attached to the polybutadiene via an ether bond. The process products according to the invention are thus distinctly different from the compounds known today from the prior art by virtue of their elevated purity.

It is preferable in this case, during the process according to the invention, to stabilize the reactants, intermediates and products using stabilizers or antioxidants in order to avoid unwanted polymerization reactions of the double bonds. Suitable for this purpose are, for example, the sterically hindered phenols known to those skilled in the art, commercially available, for example, as Anox® 20, Irganox® 1010 (BASF), Irganox® 1076 (BASF) and Irganox® 1135 (BASF).

It is further preferable to conduct one or more or all process steps under an inert atmosphere, for example under nitrogen. It is also preferable that the reactant (A), as well as the intermediates (C), (E) and (G), and also the end product (H), if they are not completely but only partially hydrogenated, be stored as far as possible with exclusion of air.

### Step a)

In step a) of the process according to the invention, at least one polybutadiene (A) is reacted with at least one epoxidizing reagent (B) to give at least one epoxy-functional polybutadiene (C).

In this reaction double bonds of the polybutadiene (A) are converted to epoxy groups. Various methods of epoxidizing polybutadienes, for example with percarboxylic acids and hydrogen peroxide, are known to the person skilled in the art and are disclosed, for example, in CN 101538338, JP 2004346310, DD 253627 and WO 2016/142249 A1. Performic acid is particularly suitable for preparation of the epoxy-functional polybutadienes (C) having a high proportion of 1,4 units and can be formed in situ from formic acid in the presence of hydrogen peroxide. The epoxidation preferably takes place in a solvent such as toluene or chloroform, which is removed by distillation after the reaction and after the washing-out of any peroxide residues.

The polybutadienes (A) are polymers of buta-1,3-diene. The polymerization of the buta-1,3-diene monomers is effected essentially with 1,4 and/or 1,2 linkage, 1,4 linkage leads to what are called 1,4-trans units and/or 1,4-cis units, which are also referred to collectively as 1,4 units, 1,2 linkage leads to what are called 1,2 units. The 1,2 units bear a vinyl group and are also referred to as vinylic 1,2 units. In the context of the present invention, the 1,2 units are also referred to as “(X)”, the 1,4-trans units as “(Y)”, and the 1,4-cis units as “(Z)”:

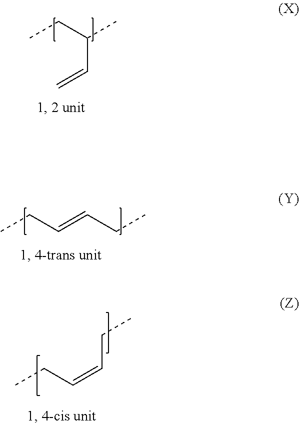

The double bonds present in the units are referred to analogously as 1,4-trans double bonds, 1,4-cis double bonds, or as 1,2 double bonds or 1,2 vinyl double bonds. The 1,4-trans double bonds and 1,4-cis double bonds are also referred to collectively as 1,4 double bonds.

The polybutadienes (A) are thus unmodified polybutadienes. The polybutadienes (A) and their preparation processes are known to the person skilled in the art. Preparation is preferably effected by means of a free-radical, anionic or coordinative chain polymerization.

Free-radical chain polymerization is preferably conducted as an emulsion polymerization. This leads to statistical occurrence of the three units mentioned. In the case of a low reaction temperature (about 5° C.), there is a fall in the proportion of vinyl groups. Initiation is preferably effected with potassium peroxodisulfate and iron salts, or else with hydrogen peroxide.

In anionic chain polymerization, the chain polymerization is preferably initiated with butyllithium. The polybutadiene (A) thus obtained contains about 40% 1,4-cis units and 50% 1,4-trans units.

In the case of coordinative chain polymerization, preference is given to using Ziegler-Natta catalysts, especially stereospecific Ziegler-Natta catalysts, that lead to a polybutadiene (A) having a high proportion of 1,4-cis units.

The polymerization of 1,3-butadiene, due to side reactions or further reactions, for example a further reaction of the double bonds of the resulting 1,2 and 1,4 units of the polybutadiene, may also result in branched polybutadienes (A). However, the polybutadienes (A) used in accordance with the invention are preferably linear, i.e. unbranched, polybutadienes. It is also possible that the polybutadienes include small proportions of units other than 1,2 units, 1,4-trans units or 1,4-cis units. However, it is preferable that the proportion by mass of the sum total of 1,2 units, 1,4-trans units and 1,4-cis units is at least 80%, preferably at least 90%, especially at least 99%, based on the total mass of the at least one polybutadiene (A), i.e. based on the total mass of all polybutadienes (A) used.

For the process according to the invention, preference is given to using those polybutadienes (A) that have 0% to 80% 1,2 units and 20% to 100% 1,4 units, more preferably 0% to 30% 1,2 units and 70% to 100% 1,4 units, still more preferably 0% to 10% 1,2 units and 90% to 100% 1,4 units, and particularly preferably 0% to 5% 1,2 units and 95% to 100% 1,4 units, based on the sum total of 1,2 units and 1,4 units.

It is therefore preferable that, of the double bonds of all the polybutadienes (A) used, 0% to 80% are 1,2 vinyl double bonds and 20% to 100% are 1,4 double bonds, more preferably 0% to 30% are 1,2 vinyl double bonds and 70% to 100% are 1,4 double bonds, even more preferably 0% to 10% are 1.2 vinyl double bonds and 90% to 100% are 1,4 double bonds, particularly preferably 0% to 5% are 1,2 vinyl double bonds and 95% to 100% are 1,4 double bonds.

For the inventive preparation of the products, accordingly, preference is given to using polybutadienes (A) of the formula (1)

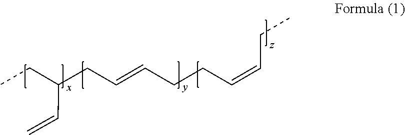

having a content of 0% to 80% 1,2 vinyl double bonds (index x) and 20% to 100% 1,4 double bonds (sum of the indices y and z), more preferably 0% to 30% 1,2 vinyl double bonds and 70% to 100% 1,4 double bonds, even more preferably 0% to 10% 1,2 vinyl double bonds and 90% to 100% 1,4 double bonds, particularly preferably having 0% to 5% 1,2 vinyl double bonds and 95% to 100% 1,4 double bonds. The ratio of 1,4-trans double bonds (index y) and 1,4-cis double bonds (index z) is freely variable.

The indices x, y and z give the number of the respective butadiene unit in the polybutadiene (A). The indices are numerical averages (number averages) over the entirety of all polybutadiene polymers of the at least one polybutadiene (A).

The average molar mass and polydispersity of the polybutadienes (A) of formula (1) used is freely variable.

It is preferable that the number-average molar mass Mn of the at least one polybutadiene (A) is from 200 g/mol to 20 000 g/mol, more preferably from 500 g/mol to 10 000 g/mol, particularly preferably from 700 g/mol to 5000 g/mol.

Alternatively, it is preferable that the number-average molar mass Mn of the at least one polybutadiene (A) is from 2100 g/mol to 20 000 g/mol, more preferably from 2200 g/mol to 10 000 g/mol, particularly preferably from 2300 g/mol to 5000 g/mol.

It is further preferable that the at least one polybutadiene (A) has a numerical average of 5 to 360, more preferably 10 to 180, particularly preferably 15 to 90 units selected from the group consisting of 1,2 units, 1,4-cis units and 1,4-trans units.

Alternatively, it is preferable that the at least one polybutadiene (A) has a numerical average of 35 to 360, more preferably 40 to 180, particularly preferably 45 to 90 units selected from the group consisting of 1,2 units, 1,4-cis units and 1,4-trans units.

It is further preferable that the viscosity of the polybutadienes (A) used is 50 to 50 000 mPas, more preferably 100 to 10 000 mPas, particularly preferably 500 to 5000 mPas (determined to DIN EN ISO 3219:1994-10).

Polybutadienes used with particular preference are the commercially available Polyvest® 110 and Polyvest® 130 products from Evonik Industries AG/Evonik Operations GmbH, having the following typical indices:
Polyvest® 110: ca. 1% 1,2 vinyl double bonds, ca. 24% 1,4-trans double bonds, ca. 75% 1,4-cis double bonds, number-average molar mass Mₙ ca. 2600 g/mol, viscosity (20° C.) 700-860 mPas (to DIN EN ISO 3219:1994-10),
Polyvest® 130: ca. 1% 1,2 vinyl double bonds, ca. 22% 1,4-trans double bonds, ca. 77% 1,4-cis double bonds, number-average molar mass Mn ca. 4600 g/mol, viscosity)(20° C. 2700-3300 mPas (to DIN EN ISO 3219:1994-10).

Polybutadienes used with particular preference are also the Lithene ultra AL and Lithene ActiV 50 products available from Synthomer PLC, having the following indices:
Lithene ultra AL: ca. 40% 1,2 vinyl double bonds, ca. 60% 1,4 double bonds,
Lithene ActiV 50: ca. 70% 1,2 vinyl double bonds, ca. 30% 1,4 double bonds.

The degree of epoxidation is determined quantitatively, for example, with the aid of ¹³C NMR spectroscopy or epoxy value titration (determinations of the epoxy equivalent according to DIN EN ISO 3001:1999) and can be adjusted in a controlled and reproducible manner via the process conditions, especially via the amount of hydrogen peroxide used in relation to the amount of double bonds in the initial charge of polybutadiene.

It is preferable in step a) of the process according to the invention that >0% to <100%, more preferably >0% to 70%, even more preferably 1% to 50%, still more preferably 2% to 40%, even more preferably from 3% to 30% and particularly preferably 4% to 20% of all double bonds of the at least one polybutadiene (A) are epoxidized.

Accordingly, it is preferable that the degree of epoxidation is >0% to <100%, more preferably >0% to 70%, even more preferably from 1% to 50%, still more preferably from 2% to 40%, still more preferably from 3% to 30% and particularly preferably from 4% to 20%.

Usable epoxidizing reagents (B) are in principle all epoxidizing agents known to the person skilled in the art. It is preferable that the epoxidizing reagent (B) is selected from the group of the peroxycarboxylic acids (percarboxylic acids, peracids), preferably from the group consisting of meta-chloroperbenzoic acid, peroxyacetic acid (peracetic acid) and peroxyformic acid (performic acid), especially peroxyformic acid (performic acid). The peroxycarboxylic acids are preferably formed in situ from the corresponding carboxylic acid and hydrogen peroxide.

It is particularly preferable that the at least one epoxidizing reagent (B) is or comprises performic acid which is preferably formed in situ from formic acid and hydrogen peroxide.

The epoxidation of the at least one polybutadiene (A) takes place preferentially at the 1,4 double bonds in a statistical distribution over the polybutadiene chain. Epoxidation of the 1,2 double bonds can likewise take place, and likewise takes place in statistical distribution over the polybutadiene chain at these bonds. However, epoxidation of the 1,2 double bonds is less favoured compared to epoxidation of the 1,4 double bonds. The reaction product thus contains epoxy-functional polybutadiene polymers that differ from one another in their degree of epoxidation. All the degrees of epoxidation stated should therefore be regarded as averages.

### Step b)

In step b) of the process according to the invention, the at least one epoxy-functional polybutadiene (C) is reacted with at least one hydroxy-functional compound (D) to give at least one hydroxy-functional polybutadiene (E).

An addition (addition reaction) of the at least one hydroxy-functional compound (D) onto the at least one epoxy-functional polybutadiene (C) takes place in this reaction. Therefore, this reaction takes place forming one or more covalent bonds between the at least one hydroxy-functional compound (D) and the at least one epoxy-functional polybutadiene (C). The reaction preferably comprises (at least idealized) a reaction step in which a nucleophilic attack takes place of at least one hydroxyl group of the at least one hydroxy-functional compound (D) on at least one epoxy group of the at least one epoxy-functional polybutadiene (C) with ring-opening of this at least one epoxy group.

In principle, in the context of the process according to the invention, all compounds having at least one hydroxyl group can be added onto the epoxy groups of the polybutadiene. Hydroxy-functional compounds (D) may be selected, for example, from the group consisting of alcohols, carboxylic acids and water. Preference is given to selecting the at least one hydroxy-functional compound (D) from the group of the monofunctional alcohols having 1 to 6 carbon atoms, more preferably from the group of the monofunctional alcohols having 2 to 4 carbon atoms, particularly preferably from the group consisting of ethanol, 1-propanol, isopropanol, 1-butanol, 2-butanol and isobutanol. It is also possible here to use any desired mixtures of these alcohols. However, it is particularly preferred that methanol is not used as the hydroxy-functional compound (D). Another suitable hydroxy-functional compound (D) is water. Water may be used alone or in a mixture with one or more other hydroxy-functional compounds (D). For example, it is possible to use mixtures of alcohol and water or mixtures of carboxylic acid and water in step b). It is thus unnecessary to dry the at least one hydroxy-functional compound (D), for example alcohol or carboxylic acid, and to free it of water.

The molar ratio of the OH groups of the hydroxy-functional compound (D) to the epoxy groups of the epoxy-functional polybutadiene (C) may be varied within a wide range. However, it is preferable to use the hydroxy-functional compounds (D) in a stoichiometric excess based on the stoichiometric ratio of hydroxyl groups to the epoxy groups of the epoxy-functional polybutadiene (C), in order to achieve quantitative conversion of all epoxy groups. It is therefore preferable that, in step b), the total number of hydroxyl groups in all the hydroxy-functional compounds (D) to the total number of epoxy groups in all the epoxy-functional polybutadienes (C) is from >1:1 to 50:1, more preferably from 2:1 to 35:1, even more preferably 3:1 to 30:1, especially preferably from 3:1 to 25:1. The excess of compound (D) may be removed, for example by distillation, after the reaction and be reused if required.

In a preferred embodiment, the reaction takes place in the presence of at least one acidic catalyst. The catalyst is optionally homogeneously soluble in the reaction mixture or distributed heterogeneously in solid form therein, for example sulfonic acid ion exchangers. In the context of the invention, preference is given to catalysts such as sulfuric acid, sulfonic acids and trifluoroacetic acid, more preferably trifluoromethanesulfonic acid. It is thus preferable that, in step b), an acid, more preferably sulfuric acid, sulfonic acids and/or trifluoroacetic acid, especially preferably trifluoromethanesulfonic acid, is used as catalyst.

The type of acid and the amount used are chosen so as to achieve very rapid and quantitative addition of the at least one hydroxy-functional compound (D) onto the epoxy groups of the at least one epoxy-functional polybutadiene (C). Preference is given to using trifluoromethanesulfonic acid at a concentration of 1 ppmw to 1000 ppmw (ppmw=ppm by mass), more preferably at a concentration of 50 ppmw to 300 ppmw, based on the reaction mixture.

The reaction of the at least one epoxy-functional polybutadiene (C) with the at least one hydroxy-functional compound (D) in the presence of an acidic catalyst preferably takes place within the temperature range from 20° C. to 120° C. and is limited at the upper end by the boiling point of the hydroxy-functional compound (D) or, when multiple hydroxy-functional compounds (D) are used, by the boiling point of the most volatile hydroxy-functional compound (D). Preference is given to conducting the reaction at 50° C. to 90° C. The components are stirred for a few hours until the epoxy groups have been converted as fully as possible. The analysis for epoxy groups can be effected either by NMR spectroscopy analysis or by known methods of epoxy value titration (as described in the examples). The reaction conditions in step b) are preferably chosen such that more than 90% of the epoxy groups generated in step a) are converted under ring-opening. It is especially preferable that no epoxy groups are detectable any longer in the product from step b), i.e. in the at least one hydroxy-functional polybutadiene (E).

After the reaction, the acidic reaction mixture is neutralized. For this purpose, it is possible in principle to add any basic neutralizing agent. The neutralization is preferably carried out using sodium hydrogen carbonate in solid form or as an aqueous solution. The possible excess hydroxy-functional compounds (D) and optionally water are preferably removed by distillation and precipitated salts are filtered off as required. Preference is given to using aqueous sodium hydrogen carbonate solution in this case, since lighter coloured products are obtained.

Each epoxy group in an epoxy-functional polybutadiene (E), after ring opening by a hydroxy-functional compound (D) of the formula A-OH, results in a repeat unit of the formula (2a), (2b) or (2c):

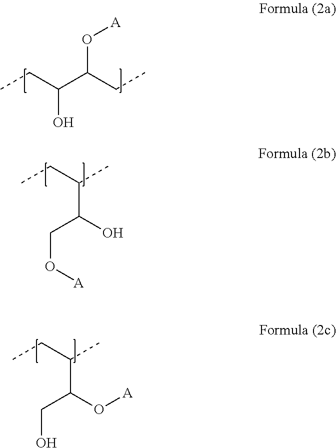

A here is preferably a monovalent organic radical that may also bear further hydroxyl groups, or a hydrogen radical. If, for example, a monofunctional aliphatic alcohol having 1 to 6 carbon atoms is used as hydroxy-functional compound (D), A is an alkyl radical having 1 to 6 carbon atoms. In the case of water as hydroxy-functional compound (D), A is a hydrogen radical. i.e. A=H. If, for example, a carboxylic acid is used as hydroxy-functional compound (D), A is an acyl radical. Each epoxy group converted thus results in at least one pendant OH group. If, as in the case of water, A=H, each epoxy group converted results in exactly two pendant OH groups. In all other cases, i.e. A #H, each epoxy group converted results in exactly one pendant OH group.

In the case of the polybutadienes (A) having a predominant proportion of 1,4 units that are preferred in accordance with the invention, those of the formula (2a) are predominant among the units of the formulae (2a), (2b) and (2c).

It is preferable that the at least one hydroxy-functional polybutadiene (E) has 20% to 100%, more preferably 70% to 100%, even more preferably 90% to 100%, especially preferably 95% to 100% units of the formula (2a), based on the sum total number of units of the formulae (2a), (2b) and (2c).

It is further preferable that the proportion of units of the formulae (2a). (2b) and (2c) taken together is from >0% to <100%, more preferably >0% to 70%, even more preferably 1% to 50%, still more preferably 2% to 40%, still more preferably 3% to 30% and especially preferably 4% to 20%, based on the total number of all units of the at least one hydroxy-functional polybutadiene (E). Accordingly, it is preferable that the degree of hydroxylation is >0% to <100%, more preferably >0% to 70%, even more preferably from 1% to 50%, still more preferably from 2% to 40%, still more preferably from 3% to 30% and particularly preferably from 4% to 20%. On completion of conversion in step b), the degree of hydroxylation of the hydroxy-functional polybutadiene (E) corresponds to the degree of epoxidation of the corresponding epoxy-functional polybutadiene (C).

### Step c)

In step c) of the process according to the invention, the at least one hydroxy-functional polybutadiene (E) is reacted with at least one epoxy-functional compound (F) to give at least one polyether-modified polybutadiene (G).

The at least one hydroxy-functional polybutadiene (E) from step b) serves, in step c), as starter compound for the reaction with the at least one epoxy-functional compound (F). Under ring opening and preferably in the presence of a suitable catalyst, the at least one epoxy-functional compound (F) (also referred to hereinafter simply as “monomer” or “epoxy monomer” or “epoxide”) is added onto the OH groups of the at least one hydroxy-functional polybutadiene (E) in a polyaddition reaction. This leads to the formation of the polybutadienes having polyether chains in comb (pendant) positions, i.e. to the formation of the at least one polyether-modified polybutadiene (G). The polyether-modified polybutadiene (G) is preferably a linear polybutadiene which has been modified with polyether radicals in comb (pendant) positions. It is thus preferable that the polyether-modified polybutadiene (G) has a linear polybutadiene backbone and pendant polyether radicals.

The reaction in step c) is preferably an alkoxylation reaction, i.e. a polyaddition of alkylene oxides onto the at least one hydroxy-functional polybutadiene (E). However, the reaction in step c) may also be conducted with glycidyl compounds alternatively or additionally to the alkylene oxides.

It is therefore preferable that the at least one epoxy-functional compound used in step c) is selected from the group of the alkylene oxides, more preferably from the group of the alkylene oxides having 2 to 18 carbon atoms, even more preferably from the group of the alkylene oxides having 2 to 8 carbon atoms, especially preferably from the group consisting of ethylene oxide, propylene oxide, 1-butylene oxide, cis-2-butylene oxide, trans-2-butylene oxide, isobutylene oxide and styrene oxide; and/or in that the at least one epoxy-functional compound used in step c) is selected from the group of the glycidyl compounds, more preferably from the group of the monofunctional glycidyl compounds, especially preferably from the group consisting of phenyl glycidyl ether, o-cresyl glycidyl ether, tert-butylphenyl glycidyl ether, allyl glycidyl ether, butyl glycidyl ether, 2-ethylhexyl glycidyl ether, C₁₂/C₁₄ fatty alcohol glycidyl ether and C₁₃/C₁₅ fatty alcohol glycidyl ether.

The monomers may be added either individually in pure form, in alternating succession in any metering sequence, or else simultaneously in mixed form. The sequence of monomer units in the resulting polyether chain is thus subject to a blockwise distribution or a statistical distribution or a gradual distribution in the end product.

By the process according to the invention, pendant polyether chains are constructed on the polybutadiene, which are exemplified in that they can be prepared in a controlled and reproducible manner in terms of structure and molar mass.

The sequence of monomer units can be varied by the sequence of addition within broad limits.

The molar masses of the pendant polyether radicals may be varied within broad limits by the process according to the invention and controlled specifically and reproducibly via the molar ratio of the added monomers in relation to the OH groups of the at least one initially charged hydroxy-functional polybutadiene (E) from step b).

The polyether-modified polybutadienes (G) and also the corresponding hydrogenated polyether-modified polybutadienes (H) prepared therefrom are preferably characterized in that they contain B radicals bonded to the polybutadiene skeleton via an ether group according to the formulae (3a), (3b) and (3c)

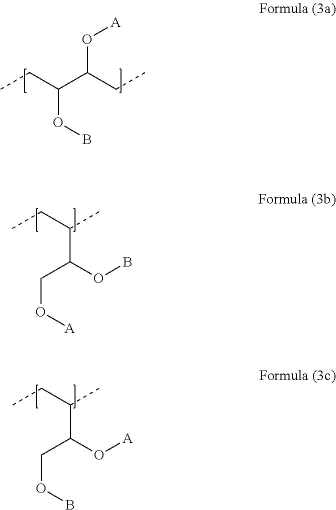

As set out above for step b), the A radical in the formulae (3a), (3b) and (3c) comes from the compound A-OH, i.e. the hydroxy-functional compound (D) used in step b). As has also been stated above, two cases are to be distinguished in step b), namely A≠H or A=H. In the first case, i.e. A≠H, the radical A in the formulae (3a), (3b) and (3c) is identical to the radical A in the formulae (2a), (2b) and (2c). In the second case. i.e. A=H, the radical A in the formulae (3a), (3b) and (3c) is in each case independently H or a radical B. If, for example, a monofunctional aliphatic alcohol having 1 to 6 carbon atoms is used as hydroxy-functional compound (D), A is an alkyl radical having 1 to 6 carbon atoms. If, for example, a carboxylic acid is used as hydroxy-functional compound (D), A is an acyl radical. If, however, water is used as hydroxy-functional compound (D), A in the formulae (3a), (3b) and (3c) is a B radical in the case of reaction with one or more epoxy-functional compounds (F); A remains hydrogen in the case that there is no reaction. Therefore, each pendant hydroxyl group converted results in exactly one pendant —O—B radical. The radical B is in turn composed of one or more monomers, preferably of two or more monomers, of the at least one epoxy-functional compound (F) used.

In the context of the invention, it is possible in principle to use all alkoxylation catalysts known to the person skilled in the art, for example basic catalysts such as alkali metal hydroxides, alkali metal alkoxides, amines, guanidines, amidines, phosphorus compounds such as phosphines (e.g. triphenylphosphine), and additionally Brønsted-acidic and Lewis-acidic catalysts such as SnCl₄, SnCl₂, SnF₂, BF₃ and BF₃ complexes, and also double metal cyanide (DMC) catalysts. The addition of an alkoxylation catalyst may be optionally omitted.

Prior to the feeding of epoxide, i.e. prior to the addition of the at least one epoxy-functional compound (F) used, the reactor partly filled with the starter and optionally the catalyst is inertized, for example with nitrogen. This is accomplished, for example, by repeated alternating evacuation and supply of nitrogen. It is advantageous to evacuate the reactor to below 200 mbar after the last injection of nitrogen. This means that the addition of the first amount of epoxy monomer preferably takes place into the evacuated reactor. The monomers are dosed while stirring and optionally cooling in order to remove the heat of reaction released and to maintain the preselected reaction temperature. The starter used is the at least one hydroxy-functional polybutadiene (E), or else it is possible to use a polyether-modified polybutadiene (G) prepared by the process of the invention as starter, as described further down.

### DMC Catalysis

Preference is given to using zinc/cobalt DMC catalysts, in particular those containing zinc hexacyanocobaltate(III). Preference is given to using the DMC catalysts described in U.S. Pat. No. 5,158,922, US 20030119663, WO 01/80994. The catalysts may be amorphous or crystalline.

It is preferable that the catalyst concentration is from >0 ppmw to 1000 ppmw, more preferably >0 ppmw to 700 ppmw, especially preferably 10 ppmw to 500 ppmw, based on the total mass of the products formed. The catalyst is preferably metered into the reactor only once. The catalyst should preferably be clean, dry and free of basic impurities that could inhibit the DMC catalyst. The amount of catalyst should preferably be set so as to give sufficient catalytic activity for the process. The catalyst may be metered in in solid form or in the form of a catalyst suspension. If a suspension is used, the OH-functional starter is especially suitable as suspension medium.

In order to start the DMC-catalysed reaction, it may be advantageous first to activate the catalyst with a portion of the at least one epoxy-functional compound (F), preferably selected from the group of the alkylene oxides, especially with propylene oxide and/or ethylene oxide. Once the alkoxylation reaction is underway, the continuous addition of the monomer may be commenced.

The reaction temperature in the case of a DMC-catalysed reaction in step c) is preferably from 60° C. to 200° C., more preferably from 90° C. to 160° C. and especially preferably from 100° C. to 140° C.

The internal reactor pressure in the case of a DMC-catalysed reaction in step c) is preferably from 0.02 bar to 100 bar, more preferably from 0.05 bar to 20 bar, especially preferably from 0.1 bar to 10 bar (absolute).

More preferably, a DMC-catalysed reaction in step c) is conducted at a temperature of 100° C. to 140° C. and a pressure of from 0.1 bar to 10 bar.

The reaction may be carried out in a suitable solvent, for example in order to lower the viscosity. At the end of the epoxide addition, there preferably follows a period of further reaction to allow the reaction to proceed to completion. The further reaction may for example be conducted by continued reaction under the reaction conditions (i.e. with maintenance of e.g. the temperature) without addition of reactants. The DMC catalyst typically remains in the reaction mixture.

Once the reaction has taken place, unreacted epoxides and any other volatile constituents can be removed by vacuum distillation, steam- or gas-stripping, or other methods of deodorization. The finished product is finally filtered at <100° C. in order to remove any cloudy substances.

### Base Catalysis

As an alternative to the DMC catalysts, it is also possible to use basic catalysts in step c). Especially suitable are alkali metal alkoxides such as sodium methoxide and potassium methoxide, which are added in solid form or in the form of their methanolic solutions. In addition, it is possible to use all alkali metal hydroxides, especially sodium hydroxide and/or potassium hydroxide, either in solid form or in the form of aqueous or alcoholic solutions, for example. In addition, it is also possible in accordance with the invention to use basic nitrogen compounds, preferably amines, guanidines and amidines, more preferably tertiary amines such as trimethylamine and triethylamine.

It is preferable to use the basic catalysts at a concentration of >0 mol % to 100 mol %, more preferably >0 mol % to 50 mol %, especially preferably 3 mol % to 40 mol %, based on the amount of OH groups in the starter.

The reaction temperature in the case of a base-catalysed reaction in step c) is preferably from 80° C. to 200° C., more preferably from 90° C. to 160° C. and especially preferably from 100° C. to 160° C.

The internal reactor pressure in the case of a base-catalysed reaction in step c) is preferably 0.2 bar to 100 bar, more preferably 0.5 bar to 20 bar, especially preferably 1 bar to 10 bar (absolute).

More preferably, the base-catalysed reaction in step c) is conducted at a temperature of 100° C. to 160° C. and a pressure of from 1 bar to 10 bar.

The reaction may optionally be performed in a suitable solvent. After the epoxide addition has ended, there preferably follows a period of further reaction to allow the reaction to proceed to completion. The further reaction can be conducted, for example, by continued reaction under reaction conditions without addition of reactants. Once the reaction has proceeded to completion, unreacted epoxides and any further volatile constituents can be removed by vacuum distillation, steam or gas stripping, or other methods of deodorization. Volatile catalysts, such as volatile amines, are removed here.

For neutralization of the basic crude products, acids such as phosphoric acid or sulfuric acid or carboxylic acids such as acetic acid and lactic acid are added. Preference is given to the use of aqueous phosphoric acid and lactic acid. The amount of the respective acid used is guided by the amount of basic catalyst used beforehand. The basic polybutadiene with pendant polyether radicals is stirred in the presence of the acid at preferably 40° C. to 95° C. and then distilled to dryness in a vacuum distillation at <100 mbar and 80° C. to 130° C. The neutralized product is finally filtered, preferably at <100° C., in order to remove precipitated salts.

It is preferable that the end products according to the invention have a water content of <0.2% (specified as proportion by mass based on the total mass of the end product) and an acid number of <0.5 mg KOH/g and are virtually phosphate-free.

### Products as Starters

It is not always possible to achieve the desired molar mass of the end product in just a single reaction step, especially the alkoxylation step. Particularly when long polyether side chains are the aim and/or the starter from step b) has a high OH functionality, it is necessary to add large amounts of epoxy monomers. This is sometimes not permitted by the reactor geometry. The polyether-modified polybutadienes (G) from step c) bear an OH group at the ends of each of their pendant polyether radicals and are therefore suitable in turn as starter for construction of conversion products of high molecular weight. In the context of the invention, they are precursors and starter compounds for the synthesis of polybutadienes having relatively long polyether radicals. The at least one epoxy-functional compound (F) can thus be converted in step c) in multiple component steps.

A product prepared with the aid of DMC catalysis in step c) may, in accordance with the invention, have its level of alkoxylation increased by new addition of epoxy monomers, either by means of DMC catalysis or with use of one of the aforementioned basic or acidic catalysts. It is optionally possible to add a further DMC catalyst in order, for example, to increase the reaction rate in the chain extension.

A product prepared under base catalysis from step c) may be alkoxylated to higher molar masses either under basic or acidic conditions or by means of DMC catalysis. In step c), neutralization is advantageously dispensed with if the aim is to react the basic precursor further with monomers under base catalysis. It is optionally possible to add a further basic catalyst in order, for example, to increase the reaction rate in the chain extension.

### Step d)

In process step d) according to the invention, the at least one polyether-modified polybutadiene (G) is hydrogenated to give at least one hydrogenated polyether-modified polybutadiene (H).

Here, the C—C double bonds of the polybutadiene (G) are partially or fully hydrogenated. The C—C double bonds are therefore partially or completely converted to C-C single bonds.

A repeating unit (X), if hydrogenated, is converted to a repeating unit (V) and a repeating unit (Y) or (Z) is correspondingly converted to a repeating unit (W):

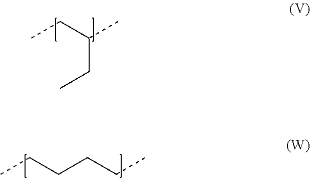

In this case, preferably at least 30%, more preferably at least 60%, even more preferably at least 90%, especially preferably at least 95% of the double bonds present in the polyether-modified polybutadiene (G) are hydrogenated. The degree of hydrogenation is preferably determined with the aid of ¹H-NMR spectroscopy, in particular as described in the examples.

It is further preferable that solvents are used in the hydrogenation, since the hydrogenated polyether-modified polybutadienes (H) usually have high viscosities. Solvents that may be used advantageously are, for example, water, alkanes, isoalkanes, cycloalkanes, alkylaromatics, alcohols, ethers and/or esters, alone or in a mixture. Advantageously employable alkanes are for example n-hexane, n-heptane, n-octane, n-nonane, n-decane, n-undecane and/or n-dodecane. Advantageously employable cycloalkanes are for example cyclohexane, methylcyclohexane, cycloheptane, cyclooctane, cyclononane, cyclodecane, cycloundecane, cyclododecane and/or decalin. Advantageously employable alkylaromatics are toluene, xylene, cumene, n-propylbenzene, ethylmethylbenzene, trimethylbenzene, solvent naphtha and/or any alkylbenzenes available on a large industrial scale. Advantageously employable alcohols are, for example, n-propyl alcohol, isopropyl alcohol and n-butyl alcohol. An advantageously employable ether is, for example, tetrahydrofuran and advantageously employable esters are, for example, ethyl acetate and butyl acetate. Particularly advantageously employable are aromatic solvents such as toluene, xylene and cumene or high-boiling esters such as butyl acetate, particular preference being given to using xylene and/or butyl acetate. The amount of solvent that may be used advantageously can be readily adjusted to the specific application by those skilled in the art. Preference is given to using between 0 and 90% by weight solvent, based on the total mass of polyether-modified polybutadienes (G) and solvent, more preferably between 0 and 80%, even more preferably between 25 and 75% and especially preferably between 40 and 60%.

The hydrogenation can be advantageously carried out in a pressure autoclave. By means of addition of hydrogen to the closed reaction vessel, a positive pressure, i.e. an elevated pressure compared to atmospheric pressure, is generated. Preferred pressures are between 1 bar and 100 bar, more preferably between 2 bar and 50 bar, particularly preferably between 3 bar and 10 bar.

Hydrogenation in the so-called bubble method is also advantageously feasible. In this process, the reaction mixture is carried out in an open reaction vessel, in which hydrogen is introduced continuously below the surface. In this case, the hydrogenation is therefore carried out under atmospheric pressure.

Regardless of whether the hydrogenation is carried out under atmospheric pressure or under positive pressure, it is preferable to ensure sufficiently good mixing of the reaction system.

The temperature in the hydrogenation is variable within wide ranges and is adjusted to the specific reaction system of catalyst and polyether-modified polybutadiene (G). It is preferable that the temperature is between 25° C. and 200° C., more preferably between 60° C. and 175° C. and particularly preferably between 100° C. and 150° C.

It is preferable that the hydrogenation is carried out with hydrogen in the presence of at least one hydrogenation catalyst.

In principle, all hydrogenation catalysts known to those skilled in the art may be used as catalysts, alone or in a mixture of two or more catalysts. The use of homogeneous and/or heterogeneous catalysts may be advantageous, the use of heterogeneous catalysts being preferred due to the ease of removal after hydrogenation.

Preferred employable noble metal catalysts, for example, are based on platinum, palladium, rhodium, iridium and ruthenium. Advantageous non-noble metal catalysts, for example, are based on nickel, copper, cobalt, manganese, molybdenum, tungsten and/or titanium. All catalysts may be used in supported form or in pure (i.e. unsupported) form.

Further preference is given to hydrogenation catalysts based on nickel, palladium, rhodium and/or ruthenium. Still more preference is given to using Raney nickel, palladium on activated carbon, ruthenium on activated carbon or rhodium as Wilkinson's catalyst (chloridotris(triphenylphosphine)rhodium(I)). Particular preference is given to using Raney nickel, palladium on activated carbon and/or Wilkinson's catalyst as hydrogenation catalyst. If mixtures of two or more of the aforementioned hydrogenation catalysts are used, then a mixture of Raney nickel and palladium on activated carbon is preferred.

The amount of catalyst used may be adjusted to the particular application. The amount used is selected so that at least hydrogenation can take place. The amount of catalyst used is preferably between 0.1% by weight and 10% by weight, more preferably between 0.2% by weight and 7% by weight, particularly preferably between 0.3% by weight and 5% by weight, based on the amount used of the polyether-modified polybutadiene (G) to be hydrogenated.

After hydrogenation is complete, the reaction mixture is preferably filtered in order to remove solids present such as the heterogeneous catalyst. Depending on the viscosity of the reaction mixture, it may be advantageous to dilute the reaction mixture prior to filtration with a suitable solvent, preferably butyl acetate or xylene.

Lastly, the filtrate obtained after filtration is distilled in order to remove highly volatile components such as solvent present and to isolate the pure hydrogenated polyether-modified polybutadiene (H) according to the invention.

### Optional Steps Cc) and Dd)

In an optional step cc), the at least one polyether-modified polybutadiene (G) without end-capped polyether radicals may be reacted with at least one end-capping reagent (I) to give at least one polyether-modified polybutadiene (G) comprising end-capped polyether radicals.

In step cc), therefore, the at least one polyether-modified polybutadiene without end-capped polyether radicals (G1) may be reacted with at least one end-capping reagent (I) to give at least one polyether-modified polybutadiene comprising end-capped polyether radicals (G2).

As an alternative to optional step cc), in an optional step dd), the at least one hydrogenated polyether-modified polybutadiene (H) without end-capped polyether radicals may be reacted with at least one end-capping reagent (I) to give at least one hydrogenated polyether-modified polybutadiene (H) comprising end-capped polyether radicals.

In step dd), therefore, the at least one hydrogenated polyether-modified polybutadiene without end-capped polyether radicals (H1) may be reacted with at least one end-capping reagent (I) to give at least one polyether-modified polybutadiene comprising end-capped polyether radicals (H2).

“End-capped polyether radicals” are understood to mean those polyether radicals having no hydroxyl groups.

In steps cc) and dd), the B radicals of the polybutadienes (G1) or (H1) having terminal hydroxyl groups are reacted preferably to give ester, ether, urethane and/or carbonate groups. The endcapping of polyethers is known to those skilled in the art, for example esterification with carboxylic acids or carboxylic anhydrides, in particular acetylation using acetic anhydride, etherification with halogenated hydrocarbons, in particular methylation with methyl chloride according to the principle of the Williamson ether synthesis, urethanization by reaction of the OH groups with isocyanates, in particular with monoisocyanates such as stearyl isocyanate, and carbonation by reaction with dimethyl carbonate and diethyl carbonate.

### Optional Step e)

In an optional step e), the at least one hydrogenated polyether-modified polybutadiene (H) may be lightened in colour.

The hydrogenated polyether-modified polybutadiene (H) may be in this case a polyether-modified polybutadiene without end-capped polyether radicals (H1) and/or a polyether-modified polybutadiene with end-capped polyether radicals (H2).

The colour lightening can be effected, for example, by adding activated carbon, preferably in a suitable solvent, or by treatment with hydrogen peroxide. The colour lightening can be determined preferably via the Gardner colour number (determined in accordance with DIN EN ISO 4630). It is preferred here that the Gardner colour number of the hydrogenated polyether-modified polybutadiene (H) is reduced in terms of the colour lightening by at least 1, preferably by at least 2.

### Hydrogenated Polyether-Modified Polybutadienes

The present invention further provides hydrogenated polybutadienes modified with polyether radicals in comb (pendant) positions, as preparable by the process according to the invention.

The invention therefore further provides a hydrogenated polyether-modified polybutadiene (H) obtainable by the process according to the invention.

The hydrogenated polyether-modified polybutadiene (H) is preferably a linear at least partially hydrogenated polybutadiene which has been modified with polyether radicals in comb (pendant) positions. It is thus preferable that the hydrogenated polyether-modified polybutadiene (H) has a linear, at least partially hydrogenated polybutadiene backbone and pendant polyether radicals.

The invention likewise further provides a hydrogenated polyether-modified polybutadiene (H), which is obtainable preferably by the process according to the invention, characterized in that the hydrogenated polyether-modified polybutadiene (H) includes units selected
both from the group consisting of the divalent radicals (S), (T) and (U):

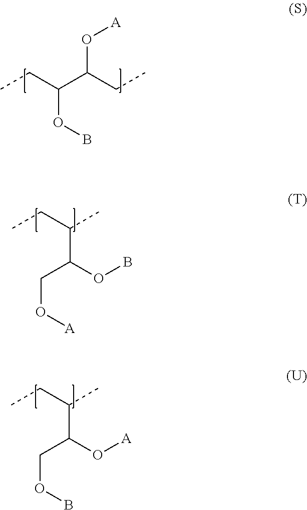

and from the group consisting of the divalent radicals (V) and (W):

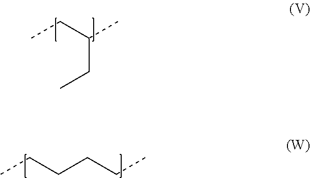

and optionally from the group consisting of the divalent radicals (X), (Y) and (Z):

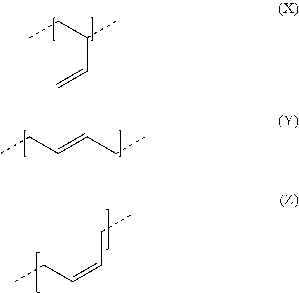

where
A is in each case independently a monovalent organic radical or a hydrogen radical, preferably in each case independently selected from the group consisting of monovalent hydrocarbon radicals having 1 to 6 carbon atoms, more preferably in each case independently selected from the group consisting of alkyl radicals having 1 to 4 carbon atoms;
B is in each case independently selected from the group consisting of radicals of the formula (4a)

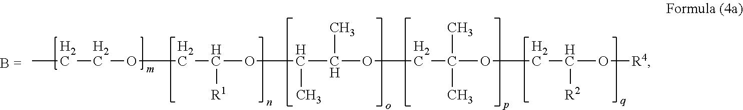

preferably in each case independently selected from the group consisting of radicals of the formula (4b)

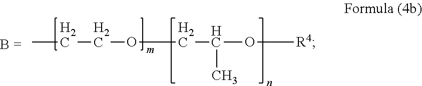

more preferably in each case independently selected from the group consisting of radicals of the formula (4c)

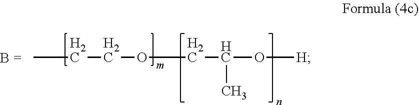

R¹ is in each case independently selected from the group consisting of monovalent hydrocarbon radicals having 1 to 16 carbon atoms, preferably in each case independently an alkyl radical having 1 to 16 carbon atoms or a phenyl radical,
   more preferably in each case independently a methyl radical, an ethyl radical or a phenyl radical;
R² is a radical of the formula —CH₂—O-R³;
R³ is in each case independently selected from the group consisting of monovalent hydrocarbon radicals having 3 to 18 carbon atoms;
   preferably in each case independently an allyl radical, a butyl radical, an alkyl radical having 8 to 15 carbon atoms or a phenyl radical that may be substituted by monovalent radicals selected from hydrocarbon radicals having 1 to 4 carbon atoms;
   more preferably a tert-butylphenyl radical or an o-cresyl radical;
R⁴ is in each case independently a monovalent organic radical having 1 to 18 carbon atoms or hydrogen, preferably hydrogen;
and
   m, n, o, p and q are each independently 0 to 300, preferably 0 to 200, more preferably 0 to 100, with the proviso that the sum total of m, n, o, p and q is greater than 1, preferably greater than 5, more preferably greater than 10;
   and each permutation of the units in the radical B, the number of which is specified by the indices m, n, o, p and q, is included.

The term “hydrogen” for a radical is a hydrogen radical.

The radicals R¹, R², R³ and R⁴ may each independently be linear or branched, saturated or unsaturated, aliphatic or aromatic, and substituted or unsubstituted.

The general notation

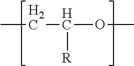

with R=R¹ or R² in formula (4a) or R=CH₃ in the formulae (4b) and (4c) represents either a unit of the formula

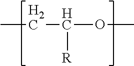

or a unit of the formula

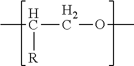

but preferably a unit of the formula

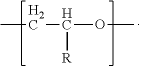

The general notation

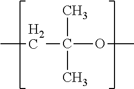

in formula (4a) represents either a unit of the formula

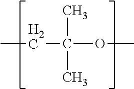

or a unit of the formula

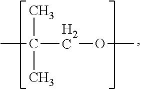

but preferably a unit of the formula

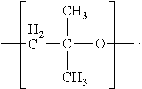

It is further preferable that the Re radical is in each case independently selected from the group consisting of monovalent hydrocarbon radicals having 1 to 18 carbon atoms, acyl radicals —C(═O)R⁵, urethane radicals —C(═O)NH—R⁸, carbonate radicals —C(═O)O—R⁷ and hydrogen; R⁴ is more preferably in each case independently selected from the group consisting of alkyl radicals having 1 to 18 carbon atoms, alkylene radicals having 1 to 18 carbon atoms, acyl radicals —C(═O)R⁵, urethane radicals —C(═O)NH—R⁸, carbonate radicals —C(═O)O—R⁷ and hydrogen; especially preferably, R⁴ is hydrogen.

R⁵ is in each case independently an alkyl or alkenyl radical having 1 to 18 carbon atoms, preferably having 1 to 10 carbon atoms, more preferably a methyl radical.

R⁸ is in each case independently an alkyl or aryl radical having 1 to 18 carbon atoms, preferably having 6 to 18 carbon atoms.

R⁷ is in each case independently an alkyl radical having 1 to 18 carbon atoms, preferably having 1 or 2 carbon atoms.

It is preferable in this case that the sum total (the total number) of all units (S), (T) and (U) divided by the sum total (the total number) of all units (S), (T), (U), (V), (W), (X), (Y) and (Z) is >0% to <100%, preferably from >0% to 70%, more preferably from 1% to 50%, still more preferably from 2% to 40%, even more preferably from 3% to 30%, particularly preferably from 4% to 20%. This means that preferably from >0% to <100%, preferably from >0% to 70%, more preferably from 1% to 50%, even more preferably from 2% to 40%, still more preferably from 3% to 30%, particularly preferably from 4% to 20% of the totality of units (S), (T), (U), (V), (W), (X), (Y) and (Z) are polyether-modified.

It is further preferable here that the sum total (the total number) of all units (V), (W), (X), (Y) and (Z) divided by the sum total (the total number) of all units (S), (T), (U), (V), (W). (X), (Y) and (Z) in the at least one polyether-modified polybutadiene (H) is from <100% to >0%, more preferably from <100% to 30%, even more preferably from 99% to 50%, even more preferably from 98% to 60%, still more preferably from 97% to 70%, most preferably from 96% to 80%. This means that preferably from <100% to >0%, more preferably from <100% to 30%, even more preferably from 99% to 50%, even more preferably from 98% to 60%, still more preferably from 97% to 70%, most preferably from 96% to 80% of the totality of units (S), (T), (U), (V), (W), (X). (Y) and (Z) are not polyether-modified.

The hydrogenated polyether-modified polybutadiene (H) may be partially hydrogenated or fully hydrogenated. However, it is preferable that the hydrogenated polyether-modified polybutadiene (H) is fully hydrogenated. It is therefore preferable that the hydrogenated polyether-modified polybutadiene (H) is essentially free from unsaturated groups.

It is therefore further preferable that the sum total (the total number) of all units (V) and (W) divided by the sum total (the total number) of all units (V). (W), (X), (Y) and (Z) of the at least one hydrogenated polyether-modified polybutadiene (H) is at least 30%, more preferably at least 60%, even more preferably at least 90%, especially preferably at least 95%. This means that at least 30%, more preferably at least 60%, even more preferably at least 90%, especially preferably at least 95% of the totality of the units (V), (W), (X), (Y) and (Z) are saturated, and that less than 30%, more preferably less than 40%, even more preferably less than 10%, especially preferably less than 5% of the totality of the units (V), (W), (X), (Y) and (Z) are unsaturated. This is preferably determined with the aid of ¹H-NMR spectroscopy, in particular as described in the examples.

It should be noted that the polyether radicals B may be unsaturated, for example if R¹ and/or R³ is a phenyl radical. However, aromatic groups are preferably not hydrogenated and are unchanged after the hydrogenation.

The number-average molar mass Mₙ, weight-average molar mass M_{w} and polydispersity of the polybutadiene moiety of the hydrogenated polyether-modified polybutadiene (H) are freely variable. The polybutadiene moiety is understood to mean the component of the hydrogenated polyether-modified polybutadiene (H) that originates from the polybutadiene (A) used in the process. The number-average molar mass Mₙ, weight-average molar mass M_{w} and polydispersity of the polybutadiene moiety of the hydrogenated polyether-modified polybutadiene (H) is therefore identical to the number-average molar mass Mₙ, weight-average molar mass M_{w} and polydispersity of the polybutadiene (A) from which the hydrogenated polyether-modified polybutadiene (H) has been prepared.

It is preferable that the number-average molar mass Mn of the polybutadiene moiety of the hydrogenated polyether-modified polybutadiene (H) is from 200 g/mol to 20 000 g/mol, preferably from 500 g/mol to 10 000 g/mol, especially preferably from 700 g/mol to 5000 g/mol.

Alternatively, it is preferable that the number-average molar mass Mn of the polybutadiene moiety of the hydrogenated polyether-modified polybutadiene (H) is from 2100 g/mol to 20 000 g/mol, preferably from 2200 g/mol to 10 000 g/mol, especially preferably from 2300 g/mol to 5000 g/mol.

The number-average molar mass Mn of the polybutadiene component is defined here as the number-average molar mass Mn of the underlying polybutadiene (A).

It is further preferable that the hydrogenated polyether-modified polybutadiene (H) has an average of 5 to 360, particularly preferably 10 to 180, especially preferably 15 to 90 units, where the units are selected from the group consisting of (S), (T). (U), (V), (W), (X), (Y) and (Z).

Alternatively, it is further preferable that the hydrogenated polyether-modified polybutadiene (H) has an average of 35 to 360, particularly preferably 40 to 180, especially preferably 45 to 90 units, where the units are selected from the group consisting of (S), (T), (U), (V), (W), (X), (Y) and (Z).

It is preferable that the proportion by mass of all units (S), (T), (U), (V), (W), (X), (Y) and (Z) taken together, based on the total mass of the at least one hydrogenated polyether-modified polybutadiene (H) is at least 50%, even more preferably at least 60%, still more preferably at least 70%, preferably at least 80%, even more preferably at least 90%, still more preferably at least 95%, still more preferably at least 99%, especially preferably 100%.

It is preferable that the hydrogenated polyether-modified polybutadiene (H) substantially or fully consists of the units (S), (T), (U), (V), (W), (X), (Y) and (Z). It is particularly preferable that the hydrogenated polyether-modified polybutadiene (H) substantially or fully consists of the units (S), (T), (U), (V) and (W).

It is particularly preferable that the hydrogenated polyether-modified polybutadienes (H) are characterized in that the proportion by mass of units (S) is at least 95%, based on the total mass of all units (S), (T), (U).

Especially preferred are those polyether-modified polybutadienes (H) which are derived from the polybutadienes Polyvest® 110 and Polyvest® 130 from Evonik Industries AG/Evonik Operations GmbH and Lithene ultra AL and Lithene ActiV 50 from Synthomer PLC described above.

The molar mass and polydispersity of the B radicals is freely variable. However, it is preferable that the average molar mass of the B radicals is from 100 g/mol to 20 000 g/mol, more preferably from 200 g/mol to 15 000 g/mol, especially preferably from 400 g/mol to 10 000 g/mol. The average molar mass of the B radicals may be calculated from the starting weight of the monomers used based on the number of OH groups of the hydroxy-functional polybutadiene (E) used. Thus, for example, if 40 g of ethylene oxide is used and the amount of the hydroxy-functional polybutadiene (E) used is 0.05 mol of OH groups, the average molar mass of the B radical is 800 g/mol.

The hydrogenated polyether-modified polybutadienes (H) are liquid, pasty or solid according to the composition and molar mass.

The number-average molar mass (Mn) of the polyether-modified polybutadienes (H) is preferably from 300 g/mol to 60 000 g/mol, more preferably from 1000 g/mol to 15 000 g/mol, even more preferably from 1500 g/mol to 10 000 g/mol, especially preferably from 2000 g/mol to 5000 g/mol.

Their polydispersity is variable within broad ranges. The polydispersity of the at least one polyether-modified polybutadiene (H) is preferably at an M_{w}/Mn of 1.5 to 15, more preferably between 2 and 10, particularly preferably between 3 and 8.

The examples that follow describe the present invention by way of example, without any intention that the invention, the scope of application of which is evident from the entirety of the description and the claims, be restricted to the embodiments specified in the examples

### EXAMPLES

### General Methods:

### Gel Permeation Chromatography (GPC):

GPC measurements for determination of polydispersity (M_{w}/Mₙ), weight-average molar mass (M_{w}) and number-average molar mass (Mₙ) were conducted under the following measurement conditions: SDV 1000/10 000 Å column combination (length 65 cm), temperature 30° C., THF as mobile phase, flow rate 1 ml/min, sample concentration 10 g/l, RI detector, evaluation against polypropylene glycol standard.

### Determination of the Content of the 1,4-Cis, 1,4-Trans and 1,2 Units in the Polybutadiene:

The content of 1,4-cis, 1,4-trans and 1,2 units can be determined with the aid of ¹H-NMR spectroscopy. This method is familiar to the person skilled in the art.

### Determination of the Content of Epoxy Groups in the Epoxy-Functional Polybutadiene (C) (Epoxy Content, Degree of Epoxidation):

The content of epoxy groups was determined with the aid of ¹³C-NMR spectroscopy. A Bruker Avance 400 NMR spectrometer was used. The samples were for this purpose dissolved in deuterochloroform. The epoxy content is defined as the proportion of epoxidized butadiene units in mol % based on the entirety of all epoxidized and non-epoxidized butadiene units present in the sample. This corresponds to the number of epoxy groups in the epoxy-functional polybutadiene (C) divided by the number of double bonds in the polybutadiene (A) used.

### Determination of the Degree of Hydrogenation:

The determination of the degree of hydrogenation was carried out with the aid of ¹H-NMR spectroscopy. A Bruker Avance 400 NMR spectrometer was used. The samples were for this purpose dissolved in deuterochloroform.

The double bond content of the polyether-modified polybutadiene (G) (i.e. prior to hydrogenation) was first determined, and also the double bond content of the hydrogenated polyether-modified polybutadiene (H) after hydrogenation. For this purpose, the integrals of the ¹H-NMR spectra between 4.8 and 6.3 ppm were determined before and after hydrogenation, which are proportional to the number of double bonds in the polybutadiene (“PB”) before (I_{PB,before}) and after (I_{PB,after}) hydrogenation. For the purpose of normalization, these integrals were based in this case in relation to the integrals of the ¹H-NMR spectra between 2.8 and 4.2, which are proportional to the (unchanged) number of hydrogen atoms in the polyether backbone (“PE”), here also in each case before (IPE before) and after (IPE, after) hydrogenation. The degree of hydrogenation is then determined according to the following equation:

$$Degree of hydrogenation = 1 - [ ( {I}_{PB , after} / {I}_{PE , after} ) / ( {I}_{PB , before} / {I}_{PE , before} ) ]$$

$${I}_{PB , after} = Integral of {the }^{1} H - NMR spectrum between 4.8 and 6.3 ppm after hydrogenation$$

$${I}_{PE , after} = Integral of {the }^{1} H - NMR spectrum between 2.8 and 4.2 ppm after hydrogenation$$

$${I}_{PB , before} = Integral of {the }^{1} H - NMR spectrum between 4.8 and 6.3 ppm before hydrogenation$$

$${I}_{PE , before} = Integral of {the }^{1} H - NMR spectrum between 2.8 and 4.2 ppm before hydrogenation$$

### Determination of the Acid Value:

The acid value was determined by a titration method in accordance with DIN EN ISO 2114.

### Determination of the Colour Lightening:

The colour lightening was determined by the change in the Gardner colour number (determined in accordance with DIN EN ISO 4630).

### Synthesis Examples

### Step a), Preparation of Epoxidized Polybutadienes

### Example A1

An epoxidized polybutadiene was prepared using a polybutadiene of the formula (1) having the structure x=1%, y=24% and z=75% (Polyvest® 110). According to the prior art, a 2.5L four-necked flask was initially charged with 800 g of Polyvest® 110 and 43.2 g of conc. formic acid in 800 g of chloroform at room temperature under a nitrogen atmosphere. Subsequently, 160 g of 30% H₂O₂ solution (30% by weight H₂O₂ based on the total mass of the aqueous solution) was slowly added dropwise and then the solution was heated to 50° C. for 7.5 hours. After the reaction had ended, the mixture was cooled to room temperature, the organic phase was separated off and washed four times with dist. H2O. Excess chloroform and residual water were distilled off. 755 g of the product were obtained, which was admixed with 1000 ppm of Irganox® 1135 and stored under nitrogen.

Evaluation by means of ¹³C NMR gave an epoxidation level of about 8.3% of the double bonds.

$${M}_{w} = 4817 g / mol ; {M}_{n} = 1997 g / mol ; {M}_{w} / {M}_{n} = 2.4$$

### Example A2

In accordance with the process described in Example A1, a 2L four-necked flask was initially charged with 800 g of Polyvest® 110 and 43.2 g of conc. formic acid in 800 g of chloroform, and 24 g of 30% H₂O₂ solution (30% by weight H₂O₂, based on the total mass of the aqueous solution) were added. After 8 hours at 50° C., phase separation, washing with dist. H₂O and subsequent distillation, 746 g of an epoxidized polybutadiene having an epoxidation level of ca. 8.6% of the double bonds by ¹³C-NMR analysis were achieved.

$${M}_{w} = 4444 g / mol ; {M}_{n} = 1940 g / mol ; {M}_{w} / {M}_{n} = 2.3$$

### Example A3

In accordance with the process described in Example A1, a 5L four-necked flask was initially charged with 1500 g of Polyvest® 110 and 81 g of conc. formic acid in 1500 g of chloroform, and 300 g of 30% H₂O₂ solution (30% by weight H₂O₂, based on the total mass of the aqueous solution) were added. After 6.5 hours at 50° C., phase separation, washing with dist. H₂O and subsequent distillation, 1453 g of an epoxidized polybutadiene having an epoxidation level of ca. 7.6% of the double bonds by ¹³C-NMR analysis were achieved.

$${M}_{w} = 4698 g / mol ; {M}_{n} = 1982 g / mol ; {M}_{w} / {M}_{n} = 2.4$$

### Example A4

In accordance with the process described in Example A1, a 5L four-necked flask was initially charged with 1500 g of Polyvest® 110 and 81 g of conc. formic acid in 1500 g of chloroform, and 300 g of 30% H₂O₂ solution (30% by weight H₂O₂, based on the total mass of the aqueous solution) were added. After 6.5 hours at 50° C., phase separation, washing with dist. H₂O and subsequent distillation, 1462 g of an epoxidized polybutadiene having an epoxidation level of ca. 8.3% of the double bonds by ¹³C-NMR analysis were achieved.

$${M}_{w} = 4464 g / mol ; {M}_{n} = 1898 g / mol ; {M}_{w} / {M}_{n} = 2.4$$

### Step b), Preparation of OH-Functional Polybutadienes

### Example B1

A hydroxylated polybutadiene having a degree of hydroxylation of ca. 8.3% was prepared using the epoxidized polybutadiene prepared in Example A1. The degree of hydroxylation here is the number of OH groups of the OH-functional polybutadiene divided by the number of double bonds in the polybutadiene used in step a). For the preparation, a four-necked flask was initially charged with 750 g of the epoxidized polybutadiene in 750 g of isobutanol under a nitrogen atmosphere, and 80 ppmw of trifluoromethanesulfonic acid (based on mass of epoxidized polybutadiene) dissolved in isobutanol (1% solution, i.e. 1% by weight trifluoromethanesulfonic acid based on the total mass of the solution) were added while stirring. This was followed by heating to 70° C. and stirring of the mixture at this temperature for 5 hours. The reaction mixture became clear during the reaction. After the reaction had ended, the mixture was cooled to room temperature and the solution was neutralized by adding 33.5 mg of solid NaHCO₃ and then filtered. The excess alcohol was distilled off under reduced pressure. The alcohol recovered by distillation and optionally dried may be reused in subsequent syntheses, 785 g of a brownish product were obtained, which was admixed with 1000 ppm of Irganox® 1135 and stored under nitrogen.

Evaluation by means of ¹³C-NMR showed complete conversion of all epoxy groups, which gives a degree of hydroxylation of ca. 8.3%.

$${M}_{w} = 9201 g / mol ; {M}_{n} = 2426 g / mol ; {M}_{w} / {M}_{n} = 3.8$$

### Example B2

For preparation of a hydroxylated polybutadiene having a degree of hydroxylation of ca. 8.6%, by the process described in Example B1, 725 g of the epoxidized polybutadiene prepared in example A2 were initially charged in 725 g of isobutanol, and 80 ppmw of trifluoromethanesulfonic acid (based on mass of epoxidized polybutadiene) dissolved in isobutanol (1% solution) were added while stirring. After stirring at 70° C. for 4.5 hours, the reaction mixture was neutralized at room temperature (RT) with 33.5 mg of solid NaHCO₃, filtered, and the excess alcohol was distilled off under reduced pressure, 749 g of a brownish product were obtained, which was admixed with 1000 ppm of Irganox® 1135 and stored under nitrogen.

Evaluation by means of ¹³C-NMR showed complete conversion of all epoxy groups, which gives a degree of hydroxylation of ca. 8.6%.

$${M}_{w} = 10305 g / mol ; {M}_{n} = 2483 g / mol ; {M}_{w} / {M}_{n} = 4.2$$

### Example B3

For preparation of a hydroxylated polybutadiene having a degree of hydroxylation of ca. 7.6%, by the process described in Example B1, 1400 g of the epoxidized polybutadiene prepared in example A3 were initially charged in 1400 g of isobutanol, and 80 ppmw of trifluoromethanesulfonic acid (based on mass of epoxidized polybutadiene) dissolved in isobutanol (1% solution) were added while stirring. After stirring at 70° C. for 7 hours, the reaction mixture was neutralized at RT with 62.7 mg of solid NaHCO₃, filtered, and the excess alcohol was distilled off under reduced pressure, 1455.6 g of a brownish product were obtained, which was admixed with 1000 ppm of Irganox® 1135 and stored under nitrogen.

Evaluation by means of ¹³C-NMR showed complete conversion of all epoxy groups, which gives a degree of hydroxylation of ca. 7.6%.

$${M}_{w} = 7441 g / mol ; {M}_{n} = 2231 g / mol ; {M}_{w} / {M}_{n} = 3.3$$

### Example B4

For preparation of a hydroxylated polybutadiene having a degree of hydroxylation of ca. 8.3%, by the process described in Example B1, 1350 g of the epoxidized polybutadiene prepared in example A4 were initially charged in 1350 g of isobutanol, and 80 ppmw of trifluoromethanesulfonic acid (based on mass of epoxidized polybutadiene) dissolved in isobutanol (1% solution) were added while stirring. After stirring at 70° C. for 7 hours, the reaction mixture was neutralized at RT with 60.5 mg of solid NaHCO₃, filtered, and the excess alcohol was distilled off under reduced pressure, 1342.1 g of a brownish product were obtained, which was admixed with 1000 ppm of Irganox® 1135 and stored under nitrogen.

Evaluation by means of ¹³C-NMR showed complete conversion of all epoxy groups, which gives a degree of hydroxylation of ca. 8.3%.

$${M}_{w} = 8277 g / mol ; {M}_{n} = 2340 g / mol ; {M}_{w} / {M}_{n} = 3.5$$

### Step c), Alkoxylation of OH-Functional Polybutadienes

### Example C1

A 3 litre autoclave was initially charged with 253 g of the hydroxylated polybutadiene prepared in Example B1 and 7.2 g of 30% sodium methoxide solution (30% by weight sodium methoxide in methanol based on total mass of the solution) under nitrogen, and the mixture was stirred at 50° C. for 1 h. Subsequently, the mixture was heated up to 115° C. while stirring and the reactor was evacuated down to an internal pressure of 30 mbar in order to distillatively remove excess methanol and other volatile ingredients present. A mixture of 106 g of ethylene oxide and 696 g of propylene oxide were metered in and with cooling over 17 hours at 115° C. and max, internal reactor pressure 3.5 bar (absolute). The mixture was allowed to react at 115° C. for a further 2 hours and was then degassed. Volatiles such as residual ethylene oxide and propylene oxide were distilled off under reduced pressure. The product was cooled to 95° C., neutralized with 30% H₃PO₄ to an acid number of 0.1 mg KOH/g, and admixed with 1000 ppm of Irganox® 1135. Water was removed by distillation under reduced pressure and precipitated salts were filtered off. 980 g of the medium-viscous and orange coloured, clear alkoxylated polybutadiene were isolated and stored under nitrogen.

$${M}_{w} = 13388 g / mol ; {M}_{n} = 3321 g / mol ; {M}_{w} / {M}_{n} = 5.1$$

### Example C2

A 3 litre autoclave was initially charged with 455 g of the hydroxylated polybutadiene prepared in Example B2 and 25.9 g of 30% sodium methoxide solution (30% by weight sodium methoxide in methanol based on total mass of the solution) under nitrogen, and the mixture was stirred at 50° C. for 1 h. Subsequently, the mixture was heated up to 115° C. while stirring and the reactor was evacuated down to an internal pressure of 30 mbar in order to distillatively remove excess methanol and other volatile ingredients present, 752 g of propylene oxide were then metered in continuously and with cooling over 12 h at 115° C. and max, internal reactor pressure 3.5 bar (absolute). The mixture was allowed to react at 115° C. for a further 3.5 hours and was then degassed. Volatiles such as residual propylene oxide were distilled off under reduced pressure. The product was cooled to 95° C., neutralized with 30% H₃PO₄ to an acid number of 0.1 mg KOH/g, and admixed with 1000 ppm of Irganox® 1135. Water was removed by distillation under reduced pressure and precipitated salts were filtered off. 1134 g of the medium-viscous and orange coloured, clear alkoxylated polybutadiene were isolated and stored under nitrogen.

$${M}_{w} = 15903 g / mol ; {M}_{n} = 2672 g / mol ; {M}_{w} / {M}_{n} = 6.$$

### Example C3

A 3 litre autoclave was initially charged with 710 g of the hydroxylated polybutadiene prepared in Example B3 and 32.3 g of 30% sodium methoxide solution (30% by weight sodium methoxide in methanol based on total mass of the solution) under nitrogen, and the mixture was stirred at 50° C. for 1 h. Subsequently, the mixture was heated up to 115° C. while stirring and the reactor was evacuated down to an internal pressure of 30 mbar in order to distillatively remove excess methanol and other volatile ingredients present, 1559 g of propylene oxide were then metered in continuously and with cooling over 10.5 h at 115° C. and max, internal reactor pressure 3.5 bar (absolute). The mixture was allowed to react at 115° C. for a further 5 hours and was then degassed. Volatiles such as residual propylene oxide were distilled off under reduced pressure. The product was cooled to 95° C., and a portion of 1397 g was discharged. This was neutralized with 30% H₃PO₄ to an acid number of 0.1 mg KOH/g and admixed with 1000 ppm of Irganox® 1135. Water was removed by distillation under reduced pressure and precipitated salts were filtered off. 1175 g of the medium-viscous and orange coloured, clear alkoxylated polybutadiene were isolated and stored under nitrogen.

$${M}_{w} = 18236 g / mol ; {M}_{n} = 3037 g / mol ; {M}_{w} / {M}_{n} = 6.$$

### Example C4

The amount of 882 g of the still alkaline, alkoxylated polybutadiene remaining in the reactor in Example C3 were again heated to 115° C. and a further 606 g of propylene oxide were added continuously over 7 hours. The mixture was allowed to react at 115° C. for a further 2 hours and was then degassed. Volatiles such as residual propylene oxide were distilled off under reduced pressure. The product was cooled to 95° C., neutralized with 30% H₃PO₄ to an acid number of 0.1 mg KOH/g, and admixed with 1000 ppm of Irganox® 1135. Water was removed by distillation under reduced pressure and precipitated salts were filtered off, 1407 g of the medium-viscous and orange coloured, clear alkoxylated polybutadiene were isolated and stored under nitrogen.

$${M}_{w} = 19573 g / mol ; {M}_{n} = 2968 g / mol ; {M}_{w} / {M}_{n} = 6.6$$

### Example C5

A 3 litre autoclave was initially charged with 415 g of the hydroxylated polybutadiene prepared in Example B4 and 20.2 g of 30% sodium methoxide solution (30% by weight sodium methoxide in methanol based on total mass of the solution) under nitrogen, and the mixture was stirred at 50° C. for 1 h. Subsequently, the mixture was heated up to 115° C. while stirring and the reactor was evacuated down to an internal pressure of 30 mbar in order to distillatively remove excess methanol and other volatile ingredients present, 974 g of propylene oxide were then metered in continuously and with cooling over 11 h at 115° C. and max, internal reactor pressure 3.5 bar (absolute). The mixture was allowed to react at 115° C. for a further hour and was then degassed. Volatiles such as residual propylene oxide were distilled off under reduced pressure. The product was cooled to 95° C., neutralized with 30% H₃PO₄ to an acid number of 0.1 mg KOH/g, and admixed with 1000 ppm of Irganox® 1135. Water was removed by distillation under reduced pressure and precipitated salts were filtered off. 1472 g of the medium-viscous and orange coloured, clear alkoxylated polybutadiene were isolated and stored under nitrogen.

$${M}_{w} = 20130 g / mol ; {M}_{n} = 2928 g / mol ; {M}_{w} / {M}_{n} = 6.9$$

### Step d), Hydrogenation of the Polyether-Modified Polybutadienes

### Example D1

A 250 ml four-necked flask was initially charged with 120 g of the alkoxylated, hydroxylated polybutadiene prepared in Example C1 and 0.006 g of citric acid and 1.2 g of water under argon. Then, 6.0 g of Raney nickel (aluminium/nickel 50/50) and 1.2 g of palladium catalyst Pd-cat/C (5% Pd on activated carbon, 50% water content) were added. After heating to 120° C., 0.15 lpm (lpm=litres per minute) of hydrogen is introduced under a strong stream of argon and with stirring for 12 hours. The solid product when cooled is diluted with 100 g each of ethanol/xylene and hot-filtered after addition of 2.4 g of Harbolite 800 filter aid (from Alfa Aeser GmbH & Co KG). Gel remains on the filter disc. The filtered liquid phase is filtered again through a finer filter and distilled under reduced pressure. This gives 98 g of a brown-black cloudy product which is solid when cooled. The degree of hydrogenation is 99.7%.

$${M}_{w} = 20250 g / mol ; {M}_{n} = 3156 g / mol ; {M}_{w} / {M}_{n} = 6.42$$

### Example D2

A 500 ml four-necked flask was initially charged with 143 g of the alkoxylated, hydroxylated polybutadiene prepared in Example C2 with 143 g of butyl acetate and 0.0071 g of citric acid and 1.43 g of water under argon. Then, 1.43 g palladium catalyst Pd-cat/C (5% Pd on activated carbon, 50% water content) were added. After heating to 120° C., 0.15 lpm of hydrogen is introduced under a strong stream of argon and with stirring for 14 hours. The solid product when cooled is diluted with 100 g of butyl acetate and hot-filtered after addition of 1.5 g of Harbolite 800 filter aid. After distillation under reduced pressure, a brown-black cloudy product is obtained which is solid when cooled. The degree of hydrogenation is 93.6%.

$${M}_{w} = 16327 g / mol ; {M}_{n} = 2394 g / mol ; {M}_{w} / {M}_{n} = 6.82$$

### Example D3

A 500 ml four-necked flask was initially charged with 250 g of the alkoxylated, hydroxylated polybutadiene prepared in Example C3 and 250 g of butyl acetate under argon. Then, 12.5 g of Raney nickel (aluminium/nickel 50/50) and 2.5 g of palladium catalyst Pd-cat/C (5% Pd on activated carbon, 50% water content) were added. After heating to 120° C., 0.10 lpm of hydrogen is introduced under a strong stream of argon and with stirring for 20 hours. The product is diluted again with 50 g of butyl acetate and hot-filtered after addition of 7.5 g of Harbolite 800 filter aid. After distillation under reduced pressure, a brown-black product is obtained which is solid when cooled. The degree of hydrogenation is 98.6%.

$${M}_{w} = 17567 g / mol ; {M}_{n} = 2690 g / mol ; {M}_{w} / {M}_{n} = 6.53$$

### Example D4

A 500 ml four-necked flask was initially charged with 125 g of the alkoxylated, hydroxylated polybutadiene prepared in Example C3 and 125 g of butyl acetate under argon. Then, 1.25 g palladium catalyst Pd-cat/C (5% Pd on activated carbon, 50% water content) were added. After heating to 120° C., 0.05-0.10 lpm of hydrogen is introduced under a strong stream of argon and with stirring for 19 hours. The product is diluted again with 50 g of xylene and hot-filtered after addition of 3.75 g of Harbolite 800 filter aid. After distillation under reduced pressure, 111 g of a brown-black cloudy product is obtained which is solid when cooled. The degree of hydrogenation is 97.5%.

$${M}_{w} = 17504 g / mol ; {M}_{n} = 2720 g / mol ; {M}_{w} / {M}_{n} = 6.44$$

### Example D5

A 500 ml four-necked flask was initially charged with 125 g of the alkoxylated, hydroxylated polybutadiene prepared in Example C3 with 125 g of xylene under argon. Then, 1.25 g palladium catalyst Pd-cat/C (5% Pd on activated carbon, 50% water content) were added. After heating to 120° C., 0.05-0.10 lpm of hydrogen is introduced under a strong stream of argon and with stirring for 28 hours. The product is diluted again with 50 g of xylene and hot-filtered after addition of 3.75 g of Harbolite 800 filter aid. After distillation under reduced pressure, 112 g of a brown-black product is obtained which is solid when cooled. The degree of hydrogenation is 91.2%.

$${M}_{w} = 19011 g / mol ; {M}_{n} = 2921 g / mol ; {M}_{w} / {M}_{n} = 6.51$$

### Example D6

A 500 ml four-necked flask was initially charged with 92.2 g of the alkoxylated, hydroxylated polybutadiene prepared in Example C3 and 276.6 g of butyl acetate under argon. Then, 0.92 g palladium catalyst Pd-cat/C (5% Pd on activated carbon, 50% water content) were added. After heating to 120° C., 0.05-0.10 lpm of hydrogen is introduced under a strong stream of argon and with stirring for 22 hours. The mixture was hot-filtered after addition of 2.8 g of Harbolite 800 filter aid. After distillation under reduced pressure, 82 g of a brown-black product is obtained which is solid when cooled. The degree of hydrogenation is 98.5%.

$${M}_{w} = 16574 g / mol ; {M}_{n} = 2637 g / mol ; {M}_{w} / {M}_{n} = 6.29$$

### Example D7

A 350 ml pressure reactor was initially charged with 125 g of the alkoxylated, hydroxylated polybutadiene prepared in Example C4 and 125 g of butyl acetate under argon. Then, 6.25 g of Raney nickel (aluminium/nickel 50/50) and 1.25 g of palladium catalyst Pd-cat/C (5% Pd on activated carbon, 50% water content) were added. After inertized heating to 140° C. and, while stirring, 5-8 bar hydrogen pressure is applied discontinuously for 40 hours. When hydrogen uptake is complete, a sample is filtered and distilled. This gives a brown-black product which is solid when cooled. The degree of hydrogenation is 47.4%.

$${M}_{w} = 20107 g / mol ; {M}_{n} = 3197 g / mol ; {M}_{w} / {M}_{n} = 6.29$$

### Example D8

A 2000 ml four-necked flask was initially charged with 493 g of the alkoxylated, hydroxylated polybutadiene prepared in Example C4 and 493 g of butyl acetate under argon. Then, 24.66 g of Raney nickel (aluminium/nickel 50/50) and 4.93 g of palladium catalyst Pd-cat/C (5% Pd on activated carbon, 50% water content) were added. After heating to 120° C., 0.10-0.15 lpm of hydrogen is introduced under a strong stream of argon and with stirring for 30 hours. The product is diluted again with 197 g of xylene and hot-filtered after addition of 14.8 g of Harbolite 800 filter aid. After distillation under reduced pressure, 458 g of a brown-black product is obtained which is solid when cooled. The degree of hydrogenation is 92.3%.

$${M}_{w} = 17933 g / mol ; {M}_{n} = 2687 g / mol ; {M}_{w} / {M}_{n} = 6.67$$

### Example D9

A 500 ml four-necked flask was initially charged with 50 g of the alkoxylated, hydroxylated polybutadiene prepared in Example C5 together with 150 g of xylene and 1.5 g of rhodium-100 (Wilkinson's catalyst) were added with stirring. After heating to 120° C., 0.025-0.05 lpm (lpm=litres per minute) of hydrogen is introduced under a strong stream of argon and with stirring for 10 hours. The mixture is hot-filtered after addition of 1.5 g of Harbolite 800 filter aid. The filtered liquid phase is distilled under reduced pressure. This gives 46 g of a brown-black cloudy product which is solid when cooled. The degree of hydrogenation is 97.8%.

$${M}_{w} = 17225 g / mol ; {M}_{n} = 2754 g / mol ; {M}_{w} / {M}_{n} = 6.25$$

### Example D10

A 500 ml four-necked flask was initially charged with 50 g of the alkoxylated, hydroxylated polybutadiene prepared in Example C5 together with 150 g of xylene and 2.5 g of ruthenium on activated carbon (H105 XBA type) was added with stirring. After heating to 120° C., 0.025-0.05 lpm (lpm=litres per minute) of hydrogen is introduced under a strong stream of argon and with stirring for 27 hours. The mixture is hot-filtered after addition of 1.5 g of Harbolite 800 filter aid. The filtered liquid phase is distilled under reduced pressure. This gives 41 g of a brown-black cloudy product which is viscous when cooled. The degree of hydrogenation is 42.0%.

$${M}_{w} = 16 \; 630 g / mol ; {M}_{n} = 2988 g / mol ; {M}_{w} / {M}_{n} = 5.55$$

1. A process for preparing one or more hydrogenated polyether-modified polybutadienes, comprising:
a) reacting at least one polybutadiene (A) with at least one epoxidizing reagent (B) to give at least one epoxy-functional polybutadiene (C);
b) reacting the at least one epoxy-functional polybutadiene (C) with at least one hydroxy-functional compound (D) to give at least one hydroxy-functional polybutadiene (E);
c) reacting the at least one hydroxy-functional polybutadiene (E) with at least one epoxy-functional compound (F) to give at least one polyether-modified polybutadiene (G); and
d) hydrogenating the at least one polyether-modified polybutadiene (G) to give at least one hydrogenated polyether-modified polybutadiene (H).

2. The process according to claim 1, further comprising precisely one of the two steps:
cc) reacting at least one polyether-modified polybutadiene (G) without end-capped polyether radicals with at least one end-capping reagent (I) to give at least one polyether-modified polybutadiene (G) comprising end-capped polyether radicals; and
dd) reacting at least one hydrogenated polyether-modified poly butadiene (H) without end-capped polyether radicals with at least one end-capping reagent (I) to give at least one hydrogenated polyether-modified polybutadiene (H) comprising end-capped polyether radicals.

3. The process according to claim 1 wherein in a)>0% to <100% of the double bonds of the at least one polybutadiene (A) are epoxidized.

4. The process according to claim 1, wherein the at least one epoxidizing reagent (B) is or comprises performic acid.

5. The process according to claim 1, wherein the at least one hydroxy-functional compound (D) is at least one selected from the group consisting of the monofunctional alcohols having 1 to 6 carbon atoms.

6. The process according to claim 1, wherein the at least one epoxy-functional compound used in c) is at least one selected
a. from the group consisting of alkylene oxides,
and/or
b. from the group consisting of glycidyl compounds.

7. The process according to claim 1, wherein in process step d), at least 30% of the double bonds of the at least one polyether-modified polybutadiene (G) are hydrogenated.

8. The process according to claim 1, wherein step d) is carried out with hydrogen in the presence of at least one hydrogenation catalyst.

9. A hydrogenated polyether-modified polybutadiene (H), obtainable by the process according to claim 1.

10. The hydrogenated polyether-modified polybutadiene (H) according to claim 9, which comprises units selected
both from the group consisting of divalent radicals (S), (T) and (U): 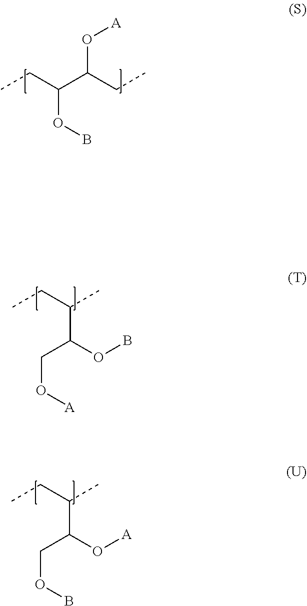
and from the group consisting of divalent radicals (V) and (W): 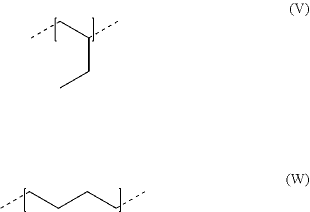
and optionally from the group consisting of divalent radicals (X), (Y) and (Z): 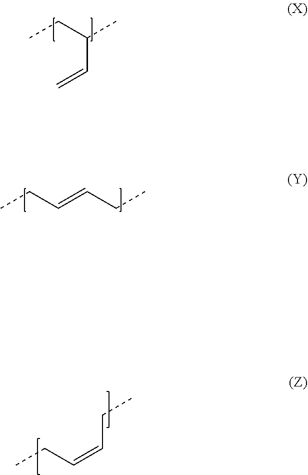
where
A is in each case independently a monovalent organic radical or a hydrogen radical;
B is in each case independently selected from the group consisting of radicals of the formula (4a) 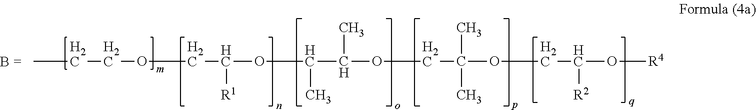
R¹ is in each case independently selected from the group consisting of monovalent hydrocarbon radicals having 1 to 16 carbon atoms
R² is a radical of the formula —CH₂—O—R³;
R³ is in each case independently selected from the group consisting of monovalent hydrocarbon radicals having 3 to 18 carbon atoms;
R⁴ is in each case independently a monovalent organic radical having 1 to 18 carbon atoms or hydrogen;
and
m, n, o, p, and q are each independently 0 to 300 with the proviso that the sum total of m, n, o, p and q is greater than 1;
and each permutation of the units in the radical B, the number of which is specified by the indices m, n, o, p and q, is included.

11. The hydrogenated polyether-modified polybutadiene (H) according to claim 9, wherein a sum total of all units (S), (T) and (U) divided by a sum total of all units (S), (T), (U), (V), (W), (X), (Y) and (Z) is >0%.

12. The hydrogenated polyether-modified poly butadiene (H) according to claim 9, wherein a sum total of all units (V) and (W) divided by a sum total of all units (V), (W), (X), (Y) and (Z) of the at least one polyether-modified polybutadiene (H) is at least 30%.

13. The hydrogenated polyether-modified polybutadiene (H) according to claim 9, wherein a number-average molar mass Mₙ of the original polybutadiene moiety is from 200 g/mol to 20 000 g/mol.

14. The hydrogenated polyether-modified polybutadiene (H) according to claim 9, wherein a average molar mass of the B radical is from 100 g/mol to 20 000 g/mol.

15. The hydrogenated polyether-modified poly butadiene (H) according to claim 9, wherein a number-average molar mass Mₙ is from 300 g/mol to 60 000 g/mol.

16. The process according to claim 3, wherein 4% to 20% of the double bonds of the at least one polybutadiene (A) are epoxidized.

17. The process according to claim 4, wherein performic acid is formed in situ from formic acid and hydrogen peroxide.

18. The process according to claim 5, wherein the at least one hydroxy-functional compound (D) is at least one selected from the group consisting of ethanol, I-propanol, isopropanol, I-butanol, 2-butanol and isobutanol.

19. The process according to claim 6, wherein the at least one epoxy-functional compound used in c) is at least one selected
a. from the group consisting of ethylene oxide, propylene oxide, 1-butylene oxide, cis-2-butylene oxide, trans-2-butylene oxide, isobutylene oxide and styrene oxide, and/or
b. from the group consisting of phenyl glycidyl ether, o-cresyl glycidyl ether, tert-butylphenyl glycidyl ether, allyl glycidyl ether, butyl glycidyl ether, 2-ethylhexyl glycidyl ether, C₁₂/C₁₄ fatty alcohol glycidyl ether and C₁₃/C₁₅ fatty alcohol glycidyl ether.

20. The process according to claim 7, wherein at least 95% of the double bonds of the at least one polyether-modified polybutadiene (G) are hydrogenated.
